(19) United States
(12) Patent Application Publication
(10) Pub. No.: US 2024/0362143 A1
(43) Pub. Date: Oct. 31, 2024

(54) IDENTIFYING UNUSED PROCESSES IN COMPUTING SYSTEMS

(71) Applicant: INTERNATIONAL BUSINESS MACHINES CORPORATION, Armonk, NY (US)

(72) Inventors: Zachary A. SILVERSTEIN, Georgetown, TX (US); Nadiya KOCHURA, Bolton, MA (US); Fang LU, Billerica, MA (US); Jonathan D. DUNNE, Dungarvan (IE)

(21) Appl. No.: 18/308,873

(22) Filed: Apr. 28, 2023

(51) Int. Cl. G06F 11/34; G06F 11/07

(52) U.S. Cl. CPC G06F 11/3423; G06F 11/0775; G06F 11/0781

(57) ABSTRACT

A method, system, and computer program product are configured to: create a process classification model using historic transactional data of historic processes in a computing system, wherein the process classification model generates a probability that a process is in an unused state; detect current processes in the computing system; generate a probability score of a respective one of the current processes using current transactional data of the respective one of the current processes with the process classification model; and perform an action with the respective one of the current processes based on the probability score of the respective one of the current processes exceeding a predefined threshold.

### BACKGROUND

Aspects of the present invention relate generally to managing processes running in a computing system and, more particularly, to identifying unused processes in a computing system.

A process table is a data structure maintained in the kernel of an operating system that stores information about all currently running processes in the system. A defunct process (also called a zombie process) is a child process that has completed execution in a computing system but has not been reaped by its parent process. Orphan processes are those child processes that are still running even though their parent process has terminated or finished. A process can be orphaned intentionally or unintentionally.

### SUMMARY

In a first aspect of the invention, there is a computer-implemented method including: creating, by a processor set, a process classification model using historic transactional data of historic processes in a computing system, wherein the process classification model generates a probability that a process is in an unused state; detecting, by the processor set, current processes in the computing system; generating, by the processor set, a probability score of a respective one of the current processes using current transactional data of the respective one of the current processes with the process classification model; and performing, by the processor set, an action with the respective one of the current processes based on the probability score of the respective one of the current processes exceeding a predefined threshold.

In another aspect of the invention, there is a computer program product including one or more computer readable storage media having program instructions collectively stored on the one or more computer readable storage media. The program instructions are executable to: create a process classification model by employing logistic regression with historic transactional data of historic processes in a computing system, wherein the process classification model generates a probability that a process is in an unused state; detect current processes in the computing system; generate a probability score of a respective one of the current processes using current transactional data of the respective one of the current processes with the process classification model; and perform an action with the respective one of the current processes based on the probability score of the respective one of the current processes exceeding a predefined threshold.

In another aspect of the invention, there is a system including a processor set, one or more computer readable storage media, and program instructions collectively stored on the one or more computer readable storage media. The program instructions are executable to: create a process classification model by employing feature selection and logistic regression with historic transactional data of historic processes in a computing system, wherein the process classification model generates a probability that a process is in an unused state; detect current processes in the computing system; generate a probability score of a respective one of the current processes using current transactional data of the respective one of the current processes with the process classification model; and perform an action with the respective one of the current processes based on the probability score of the respective one of the current processes exceeding a predefined threshold.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a table of exemplary transactional data that can be used to create the process classification model in accordance with aspects of the invention.

FIG. 4 shows an example of a fitted regression expression in accordance with aspects of the present invention.

FIG. 5 shows an example of using a fitted regression expression to determine a probability score for a current process in accordance with aspects of the present invention.

FIG. 6 shows an example of determining respective probability scores for plural respective current processes and taking action with certain ones of the processes based on the probability scores in accordance with aspects of the present invention.

FIG. 7 shows a diagram of an exemplary process for implementing a learning loop to detect false positive classifications of processes as unused processes in accordance with aspects of the present invention.

FIG. 8 shows a flowchart of an exemplary method in accordance with aspects of the present invention.

### DETAILED DESCRIPTION

Aspects of the present invention relate generally to managing processes running in a computing system and, more particularly, to identifying unused processes in a computing system. Connections over a network are static in nature. Current events may time out after a predefined time period to ensure that zombie connections do not tie up a system and its associated connection pool. Problems arise when a good process is terminated when the timeout value is reached, even if the process is working as expected.

A defunct process (also called a zombie process) is a process that is no longer executing, but one that remains in the process table to allow the parent process to collect its exit status information. Because defunct processes retain their process identifier (PID) and remain in the process table, and because the process table has a finite number of slots, large numbers of defunct processes in the process table can reduce the number of available slots in the process table for other processes. For example, if the number of processes in the process table reaches the maximum limit, then no new processes can be created anywhere in the entire system. Also, if the number of processes for a particular user exceeds the maximum number of processes allowed per user, no new processes can be created for that user.

Orphan processes are those processes that are still running even though their parent process has terminated or finished. A process can be orphaned intentionally or unintentionally. An intentionally orphaned process runs in the background without any manual support. This is usually done to start an indefinitely running service or to complete a long-running job without user attention. An unintentionally orphaned process is created when its parent process crashes or terminates. Orphaned processes, because they are still running, use system resources such as memory, CPU, etc.

Unused processes, including defunct (zombie) processes and unintentionally orphaned processes, can negatively affect aspects of computing system performance for the reasons described above. Static techniques for identifying unused processes are typically either underinclusive or overinclusive, thus resulting in sub-optimal results when utilized to clean up such processes. Implementations of the invention address this problem by providing a system, method, and computer program product that are configured to intelligently identify unused processes, including defunct (zombie) processes and unintentionally orphaned processes, using a machine learning model that is trained using historic transactional data of the computing system. In embodiments, the machine learning model is improved based on exception monitoring. In this manner, implementations of the invention provide a method for more accurately identifying unused processes in a computing system, which improves the managing of processes running in the computing system by allowing for terminating identified unused processes while respecting long running working (e.g., still used) processes in the computing system.

As will be understood from the present disclosure, embodiments provide for a method of managing processes running in the computing system, the method including: modeling prior transactional data (e.g., disk, RAM, CPU, network, etc.); deriving a process classification model based on the prior transactional data; using the process classification model to arbitrate what processes are considered unused processes; taking action with identified unused processes, including sending an alert and stopping the process; and generalizing the process classification model against itself and self-improving the process classification model based on exception monitoring. The method may further include building a taxonomy to provide business intelligence (BI) as to which system metrics correlate to unused processes. The method may further include identifying patterns in resource utilization metrics mapped to certain context (e.g., workload, applications run, etc.) and building the process classification model to predict unused processes so that additional monitoring and preventative steps can be initiated.

As will be understood from the present disclosure, embodiments provide for a method of managing process resource utilization, the method including: detecting a set of current processes running in a system; identifying parent and child processes in the set; evaluating child process execution according to a process classification model; and terminating a child process classified as a zombie according to the process classification model. The method may further include: identifying an orphan process according to an evaluation of parent process execution; and terminating the orphan process. The method may further include: identifying a process accessed by a valid parent or a valid child process; and maintaining execution of the valid parent or valid child application. The method may further include updating a process table according to a process classification result. The method may further include generating process monitoring rules according to a process classification result.

Implementations of the invention are necessarily rooted in computer technology. For example, the step of creating a process classification model with historic transactional data of historic processes in a computing system is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as process identifying code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

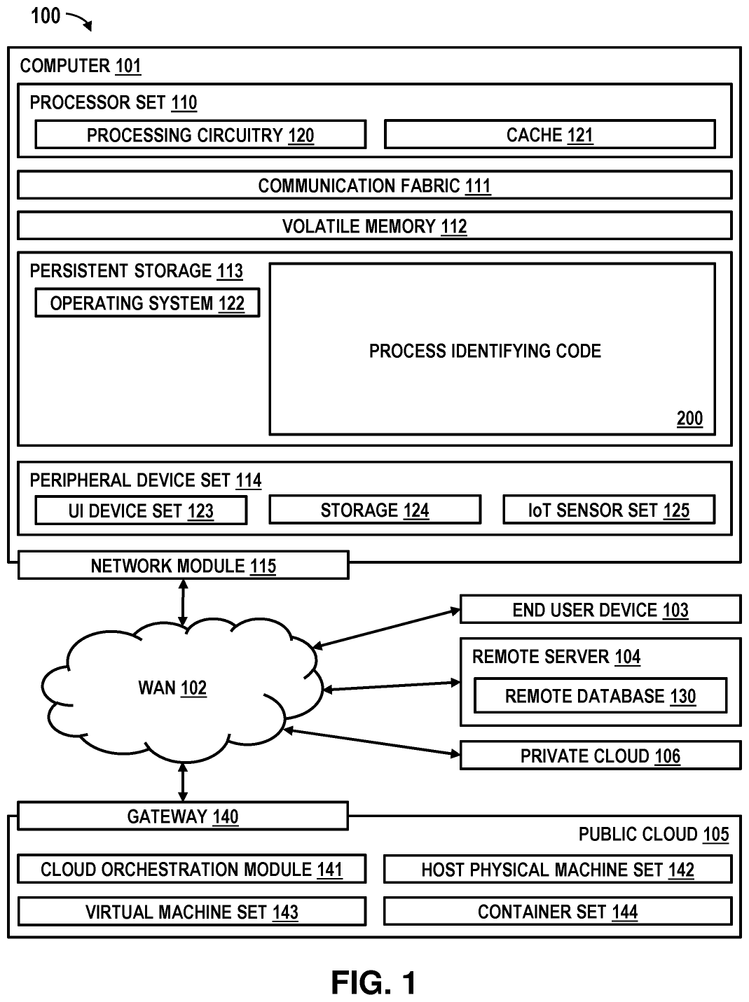

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

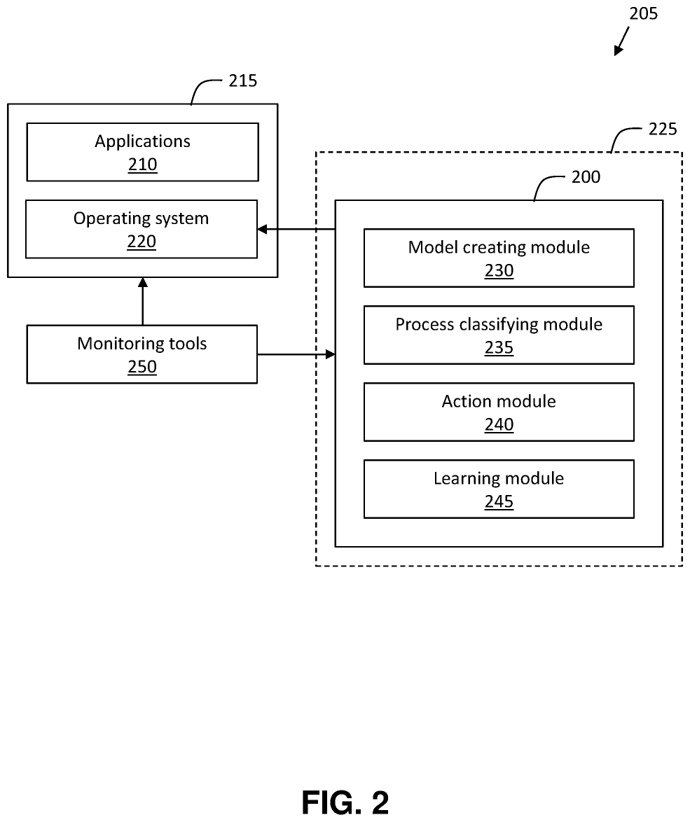

FIG. 2 shows a block diagram of an exemplary environment 205 in accordance with aspects of the invention. In embodiments, the environment 205 includes one or more applications 210 running on a computing system 215. In embodiments, each of the applications 210 comprises an application program (e.g., a computer program) designed to carry out a specific task other than one relating to the operation of a computer itself. The computing system 215 may comprise an end user device 103 of FIG. 1, a remote server 104 of FIG. 1, or a private cloud 106 of FIG. 1, for example. In embodiments, the computing system 215 comprises an operating system 220 that controls the operation of the computing system 215. In embodiments, the operating system 220 maintains a process table that lists current processes of the computing system 215. In one example, the process table is a data structure maintained in the kernel of the operating system 220, where the data structure is maintained to store information about all current processes in the computing system 215. In embodiments, each process included in the process table has a process identifier (PID). In embodiments, the process table has a finite number of slots, and if the number of processes in the process table reaches the maximum limit, then no new processes can be created anywhere in the computing system 215.

In accordance with aspects of the invention, the environment 205 also includes the process identifying code of block 200 of FIG. 1. In one example, the process identifying code of block 200 resides on and is executed by the computing system 215, for example, as part of the operating system 220. In this example, the computing system 215 may comprise the computer 101 of FIG. 1, which executes the operating system 220 and the process identifying code of block 200. In another example, the process identifying code of block 200 resides on and is executed by another computing device 225 that is separate from the computing system 215 and that communicates with the operating system 220 of the computing system 215 via network communication, such as through WAN 102 of FIG. 1. In this example, the computing device 225 may comprise one or more instances of the computer 101 of FIG. 1, which executes the process identifying code of block 200.

In embodiments, and as shown in FIG. 2, the process identifying code of block 200 comprises a model creating module 230, a process classifying module 235, an action module 240, and a learning module 245. These modules 230, 235, 240, and 245 may include routines, programs, objects, components, logic, data structures, and so on that perform particular tasks or implement particular data types that the process identifying code of block 200 uses to carry out the functions and/or methodologies of embodiments of the invention as described herein. These modules of the process identifying code of block 200 are executable by the processing circuitry 120 of FIG. 1 to perform the inventive methods as described herein. The process identifying code of block 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the model creating module 230 is configured to create a process classification model that is used to generate a probability that a process in the process table of the operating system 220 is an unused process (also referred to as being in an unused state). In embodiments, the model creating module 230 creates the process classification model using machine learning and historic transactional data of historic processes in the computing system 215. In embodiments, the model creating module 230 obtains the historic transactional data of historic processes from one or more monitoring tools 250. In embodiments, the monitoring tools 250 monitor the processes of the applications 215 and obtain transactional data about the processes based on the monitoring. The transactional data may include metrics which are quantifiable measurements that reflect the health and performance of processes in a computing system. The historic transactional data may include, but is not limited to, metrics related to disk usage in the computing system 215, metrics related to RAM usage in the computing system 215, metrics related to CPU usage in the computing system 215, metrics related to network usage in the computing system 215, and metrics related to numbers of threads in the computing system 215.

In accordance with aspects of the invention, the process classifying module 235 is configured to utilize the process classification model with current transactional data to classify current processes of the computing system 215 as either used or unused. In embodiments, the process classifying module 235 generates respective probability scores for respective ones of the current processes in the computing system 215, where a current process is a process that is included in the current version of the process table of the operating system 220. In embodiments, the probability score generated in this manner represents a likelihood that the current process is an unused process, such as a zombie process or an unintentional orphan process. For example, the probability score generated using the process classification model may have a value between a low limit and a high limit, with values closer to the low limit indicating the current process is less likely to be an unused process, and values closer to the high limit indicating the current process is more likely to be an unused process. In this manner, the process classification model can be used to identify potentially bad (i.e., unused) processes such as zombie processes that are unnecessarily taking up space in the process table and unintentionally orphaned processes that are unnecessarily utilizing system resources.

In accordance with aspects of the invention, the action module 240 is configured to perform an action with one of the current processes based on the probability score of the one of the current processes exceeding one or more predefined thresholds (e.g., based on the process being classified/identified as an unused process). In one example, there is a single threshold. In this example, for a process whose probability score is greater than the single threshold, the action module 240 generates an alert to a user, where the alert identifies the current process and indicates that the process is likely an unused process. Based on this alert, the user can take action such as monitoring the process, terminating the process, etc. In another example, there is a first threshold and a second threshold higher than the first threshold. In this example, for a process whose probability score is greater than the first threshold and less than the second threshold, the action module 240 generates an alert to a user, where the alert identifies the current process and indicates that the process is likely an unused process. In this example, for a process whose probability score is greater than the second threshold, the action module 240 automatically terminates the process.

In accordance with aspects of the invention, the learning module 245 is configured to implement a learning loop to detect false positive classifications of processes as unused processes. In embodiments, the learning module 245 detects aggregate system errors embedded in log files after a process has been terminated as a result of being classified as an unused process. The log files may be created by and obtained from the monitoring tools 250.

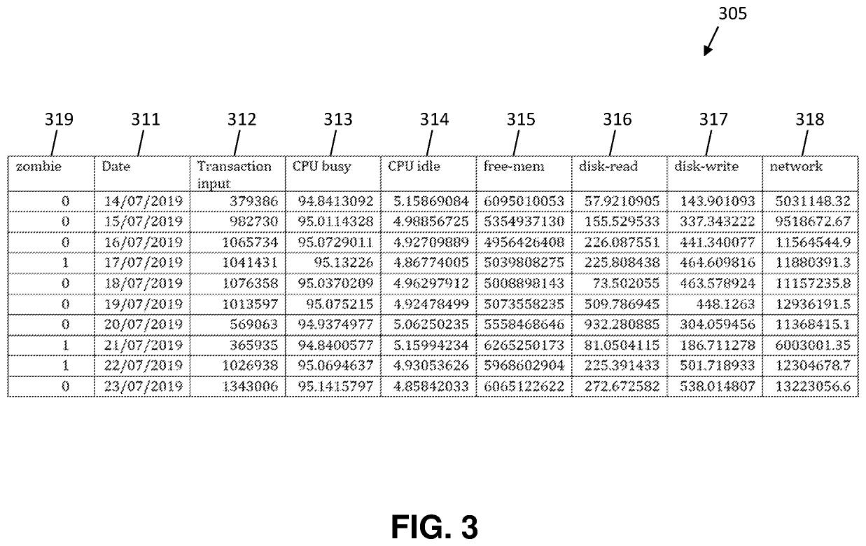

FIG. 3 shows a table 305 of exemplary transactional data that can be used to create the process classification model in accordance with aspects of the invention. In embodiments, the transactional data comprises historic transactional data of historic processes in the computing system 215 of FIG. 2, where historic processes are processes that previously ran in the computing system 215 and that are no longer running in the computing system 215 and are no longer in the process table. The transactional data can be obtained using the one or more monitoring tools 250 of FIG. 2 that monitor metrics of processes in computing systems. The transactional data may include, for example and without limitation, metrics related to disk usage in the computing system, RAM usage in the computing system, CPU usage in the computing system, network usage in the computing system. In the example shown in FIG. 3, the transactional data includes: date at column 311; transaction input at column 312; CPU busy at column 313; CPU idle at column 314; free-mem (free memory) at column 315; disk-read at column 316; disk-write at column 317; and network at column 318. The table 305 is shown with ten rows for brevity; however, such a table may include thousands or tens of thousands of rows in implementations of the invention.

In embodiments, each row in the table 305 corresponds to a historic process in the computing system 215 and the data in the columns 311-318 corresponds to the historic transactional data of the particular process of the row. In embodiments, the table 305 includes a column 319 that includes a label for the process of each row. In embodiments, the label is a classification of the process of a particular row as being an unused process (e.g., a zombie process or an unintentional orphan process). The label may be binary, e.g., with “1” indicating an unused process and “0” indicating a used process. The labels may be manually added to the rows of the table 305. To reduce user burden, all the rows may be initially set with a label value of “0” and the user may be tasked with updating the label to “1” only for those rows for which an unused process has been observed. The table 305 comprising historic transactional data in columns 311-318 and labels in column 319 constitutes labeled training data that can be used with supervised learning algorithms for creating the process classification model in accordance with aspects of the invention.

In accordance with aspects of the invention, the model creating module 230 selects a subset of the metrics with which to create the process classification model and then creates the process classification model using the historic transactional data of only the selected subset of metrics. In embodiments, the model creating module 230 selects a subset of the metrics using one or more machine learning feature selection algorithms, which may include wrapper methods, filter methods, or embedded methods, for example. In machine learning, feature selection is the process of using computer-based algorithms to select a subset of relevant features for use in model construction. In embodiments, the model creating module 230 uses feature selection to determine which of the metrics of the historic transactional data are most strongly correlated to a process being an unused process, e.g., as indicated by the labeled data. In embodiments, after selecting the subset of metrics, the model creating module 230 creates the process classification model by employing one or more logistic regression algorithms with the historic transactional data of the selected subset of metrics to derive a fitted regression expression. In embodiments, the fitted regression expression has the form shown in Equation 1.

$$log ( \frac{p}{1 - p} ) = k + {α}_{1} {M}_{1} + {α}_{2} {M}_{2} + … + {α}_{n} {M}_{n} \qquad ( Equation 1 )$$

In the fitted regression expression of Equation 1, p is the probability score for a process. In embodiments, the fitted regression expression is derived such that p has a value between 0 and 1, with values closer to 0 being less likely to be an unused process and values closer to 1 being more likely to be an unused process. In the fitted regression expression of Equation 1, k is a constant and α₁, α₂, . . . , αₙ are n number of coefficients corresponding to n number of metrics in the subset of metrics that are selected using feature selection. In embodiments, the model creating module 230 determines the values of k and α₁, α₂, . . . , αₙ by employing one or more logistic regression algorithms with the historic transactional data of the selected subset of metrics. In embodiments, once the values of k and α₁, α₂, . . . , αₙ are determined, the process classifying module 235 may use the fitted regression expression with current transactional data of a current process to determine the value of p for the current process. In this manner, the fitted regression expression with determined values of k and α₁, α₂, . . . , αₙ constitutes a process classification model that generates a probability that a process is in an unused state (e.g., an unused process).

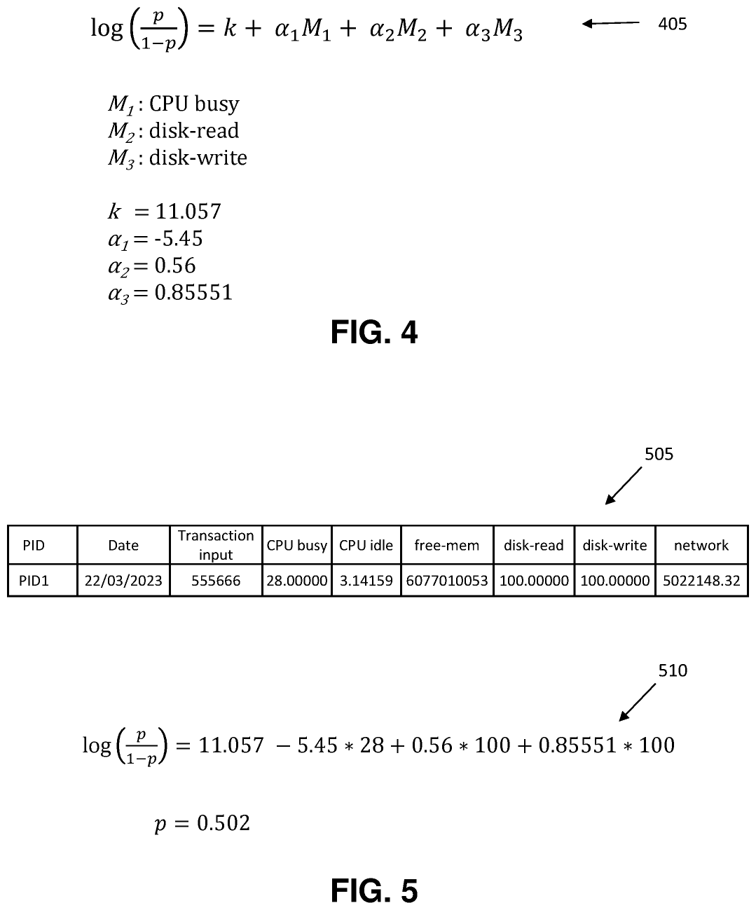

FIG. 4 shows an example of a fitted regression expression 405 that has the form of Equation 1 and that is derived from the table 305 of exemplary transactional data of FIG. 3. In this example, the model creating module 230 analyzes the data in the table 305 using one or more feature selection algorithms and, based on this, selects the metrics of CPU busy, disk-read, and disk-write as the subset of metrics for creating the process classification model. As a result of the feature selection analysis selecting 3 metrics (i.e., CPU busy, disk-read, and disk-write), the number n in the fitted regression expression is 3, where M₁ corresponds to CPU busy, M₂ corresponds to disk-read, and M₃ corresponds to disk-write. In this example, the model creating module 230 employs logistic regression using the data in the CPU busy, disk-read, and disk-write columns of the table 305 (e.g., columns 313, 316, 317) and the labels in column 319 to determine values of k=11.057, α₁=−5.45, α₂=0.56, and α₃=0.85551.

FIG. 5 shows an example of using the fitted regression expression of FIG. 4 to determine a probability score p for a current process named PID1. In this example, the process classifying module 235 determines from the monitoring tool that the current process has a value of 28 for CPU busy, a value of 100 for disk-read, and a value of 100 for disk-write, as shown in the exemplary table 505 of current transactional data including a row for the process named PID1. Operation 510 includes substituting these values 28, 100, and 100 for M₁, M₂, and M₃, respectively, in the fitted regression expression 405 of FIG. 4 Operation 510 also includes substituting the previously determined values for of k, α₁, α₂, α₃ in the fitted regression expression 405 of FIG. 4. After substituting with these values, the expression can be solved for p which has a value of 0.502 in this example. In this manner, the process classifying module 235 generates a probability score of p=0.502 for this current process named PID1. In embodiments, the process classifying module 235 determines a respective probability score in this manner for each current process in the computing system. In this way, for each process in the process table, the process classifying module 235 uses the fitted regression expression (i.e., the process classification model) to determine a probability that the process is in an unused state. In embodiments, and as described herein, the process classifying module 235 performs an action with a current process based on the probability score of the current process exceeding one or more predefined threshold values.

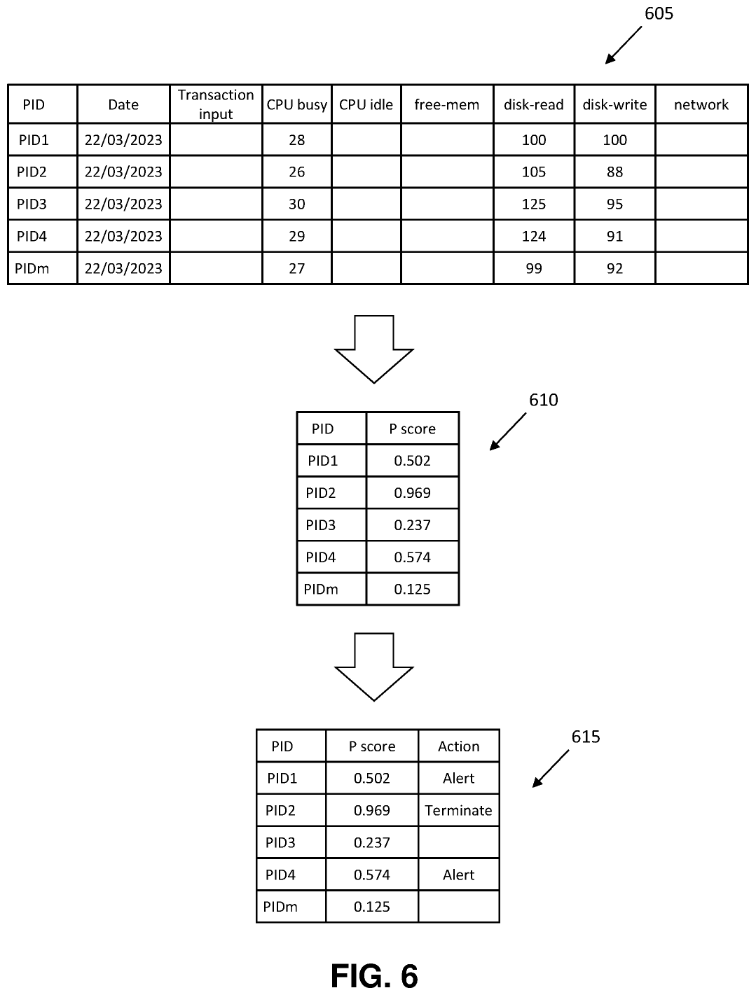

FIG. 6 shows an example of determining respective probability scores for plural respective current processes and taking action with certain ones of the processes based on the probability scores. In FIG. 6, table 605 represents the current transactional data for all the current processes in the system, indicated by PID1, PID2, PID3, PID4, . . . , PIDm, where ‘m’ is the number of current processes in the system as defined by the process table in the operating system 220. In FIG. 6, which continues the example of FIGS. 4 and 5, the table 605 shows only the data of the selected subset of metrics, which are CPU busy, disk-read, and disk-write in this example. At 610, the process classifying module 235 generates a respective probability score (p score) for each current process in the system, e.g., processes PID1, PID2, PID3, PID4, . . . , PIDm, using the process classification model and the data for each process from table 605. At 615, the action module 240 determines actions to perform for certain ones of the processes based on the probability scores of the processes. In the example of FIG. 6, the action module 240 compares the probability score of each process to a first threshold value of 0.50 and a second threshold value of 0.95. In this example, for a process whose probability score is greater than the first threshold and less than the second threshold, the action module 240 generates an alert to a user, where the alert identifies the current process and indicates that the process is likely an unused process. In this example, for a process whose probability score is greater than the second threshold, the action module 240 automatically terminates the process. Accordingly, in this example, the action module performs an alert action for the process PID1, performs a terminate action for the process PID2, performs no action for the process PID3, performs an alert action for the process PID4, and performs no action for the process PIDm. In embodiments, the alert action may comprise sending a notification to a user via one or more communication channels such as email, pager, automated telephone call, text message, etc. In embodiments, the termination action may comprise terminating the process in the computing system.

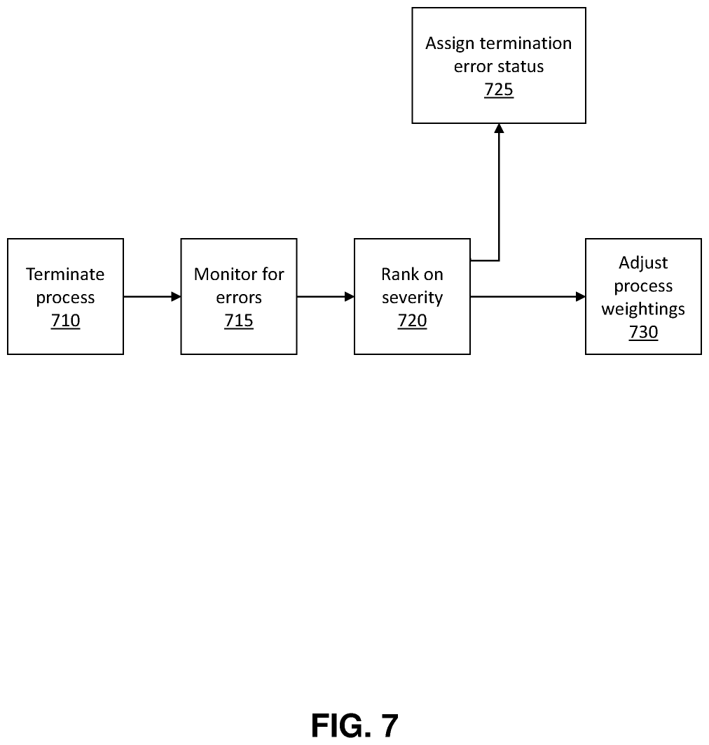

FIG. 7 shows a diagram of an exemplary process for implementing a learning loop to detect false positive classifications of processes as unused processes. In embodiments, for processes that are terminated as a result of being classified as an unused process (e.g., as a result of their probability score exceeding a threshold and a termination action being performed), the process identifying code of block 200 monitors the computing system 215 for errors that occur as a result of such a termination. The monitoring may be performed by analyzing log files and detecting system errors that identify (e.g., call back to, etc.) the terminated process. At 710, a process is terminated as a result of being classified as an unused process. At 715, the learning module 245 monitors for errors that arise from this termination. At 720, the learning module 245 ranks a detected error based on a severity determined from comparing the detected error to a knowledge base of expected errors and a knowledge base of critical processes and applications. For example, the learning module 245 may be programmed with a ranking algorithm that ranks an expected error as less severe than an unexpected error. The ranking algorithm may also rank an error detected in a critical process or application as more severe than an error detected in a non-critical process or application. The ranking algorithm may also determine the severity in part on a number of errors caused by terminating the process. At 725, the learning module 245 assigns an error status to the process that was terminated, where the error status is based on the ranking. At 730, the learning module 245 adjusts process weightings for future rulesets.

In embodiments, in response to determining the terminating of a respective one of the current processes causes an unexpected error with another process or application, the learning module 245 is configured to add the respective one of the current processes to a watchlist for further investigation. In this manner, the system and/or a user may monitor the situation for additional downstream errors related to the terminated process.

In embodiments, in response to determining the terminating of a respective one of the current processes causes an unexpected error with another process or application, the learning module 245 is configured to update the training data to include the respective one of the current processes with a revised classification (e.g., as not unused); and retrain the process classification model using the updated training data.

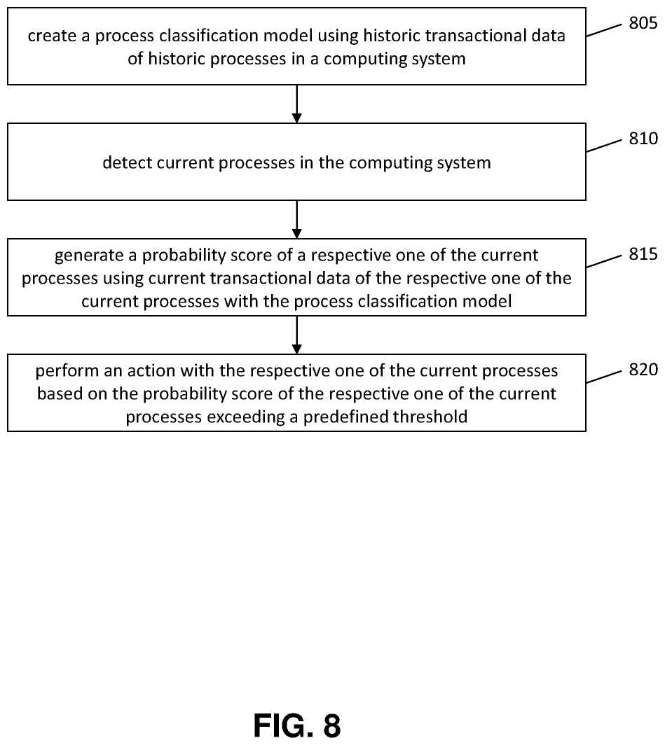

FIG. 8 shows a flowchart of an exemplary method in accordance with aspects of the present invention. Steps of the method may be carried out in the environment of FIG. 2 and are described with reference to elements depicted in FIG. 2.

At step 805, the system creates a process classification model using historic transactional data of historic processes in a computing system. For example, and as described herein, the model creating module 230 creates a process classification model that is usable to generate a probability that a process is in an unused state.

At step 810, the system detects current processes in the computing system. For example, and as described herein, the process classifying module 235 detects current processes by accessing the process table of the operating system of the computing system.

At step 815, the system generates a probability score of a respective one of the current processes using current transactional data of the respective one of the current processes with the process classification model. For example, and as described herein, the process classifying module 235 generates respective probability scores for respective ones of the current processes.

At step 820, the system performs an action with the respective one of the current processes based on the probability score of the respective one of the current processes exceeding a predefined threshold. For example, and as described herein, the action module 240 performs an action with a process whose score is greater than a predefined threshold value.

In embodiments, the method further comprises: determining the respective one of the current processes is accessed by another one of the current processes; and maintaining the respective one of the current processes in the computing system. In embodiments, prior to terminating a particular process based on its probability score, the action module 240 determines whether any other processes access the particular process. If another process accesses (e.g., calls, etc.) the particular process, then the action module 240 does not terminate the particular process and instead maintains the particular process (e.g., keeps it alive) despite its probability score exceeding a threshold that would otherwise result in termination. In this manner, the system avoids terminating a particular process that is used by another process even when the particular process has a probability score that would otherwise dictate termination.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
creating, by a processor set, a process classification model using historic transactional data of historic processes in a computing system, wherein the process classification model generates a probability that a process is in an unused state;
detecting, by the processor set, current processes in the computing system;
generating, by the processor set, a probability score of a respective one of the current processes using current transactional data of the respective one of the current processes with the process classification model; and
performing, by the processor set, an action with the respective one of the current processes based on the probability score of the respective one of the current processes exceeding a predefined threshold.

2. The method of claim 1, wherein:
the current processes comprise processes in a process table in an operating system of the computing system; and
the respective one of the current processes comprises a child process.

3. The method of claim 1, wherein the respective one of the current processes comprises a zombie process.

4. The method of claim 1, wherein the respective one of the current processes comprises an unintentional orphan process.

5. The method of claim 1, wherein the action comprises alerting a user that the respective one of the current processes is an unused process.

6. The method of claim 1, wherein the action comprises automatically terminating the respective one of the current processes.

7. The method of claim 1, wherein:
the threshold comprises a first threshold;
the action comprises alerting a user that the respective one of the current processes is an unused process based on the probability score being greater than the first threshold and less than a second threshold; and
the action comprises automatically terminating the respective one of the current processes based on the probability score being greater than the second threshold.

8. The method of claim 1, further comprising:
determining the respective one of the current processes is accessed by another one of the current processes; and
maintaining the respective one of the current processes in the computing system.

9. The method of claim 1, wherein the action comprises terminating the respective one of the current processes, and further comprising:
determining the terminating the respective one of the current processes causes an unexpected error with another one of the current processes; and
adding the respective one of the current processes to a watchlist for further investigation.

10. The method of claim 1, wherein the action comprises terminating the respective one of the current processes, and further comprising:
determining the terminating the respective one of the current processes causes an unexpected error with another one of the current processes;
updating training data to include the respective one of the current processes with a revised classification; and
retraining the process classification model using the updated training data.

11. A computer program product comprising one or more computer readable storage media having program instructions collectively stored on the one or more computer readable storage media, the program instructions executable to:
create a process classification model by employing logistic regression with historic transactional data of historic processes in a computing system, wherein the process classification model generates a probability that a process is in an unused state;
detect current processes in the computing system;
generate a probability score of a respective one of the current processes using current transactional data of the respective one of the current processes with the process classification model; and
perform an action with the respective one of the current processes based on the probability score of the respective one of the current processes exceeding a predefined threshold.

12. The computer program product of claim 11, wherein:
the current processes comprise processes in a process table in an operating system of the computing system; and
the respective one of the current processes comprises a child process.

13. The computer program product of claim 11, wherein the respective one of the current processes comprises a zombie process.

14. The computer program product of claim 11, wherein the respective one of the current processes comprises an unintentional orphan process.

15. The computer program product of claim 11, wherein the action comprises one of alerting a user that the respective one of the current processes is an unused process and automatically terminating the respective one of the current processes.

16. A system comprising:
a processor set, one or more computer readable storage media, and program instructions collectively stored on the one or more computer readable storage media, the program instructions executable to:
create a process classification model by employing feature selection and logistic regression with historic transactional data of historic processes in a computing system, wherein the process classification model generates a probability that a process is in an unused state;
detect current processes in the computing system;
generate a probability score of a respective one of the current processes using current transactional data of the respective one of the current processes with the process classification model; and
perform an action with the respective one of the current processes based on the probability score of the respective one of the current processes exceeding a predefined threshold.

17. The system of claim 16, wherein:
the threshold comprises a first threshold;
the action comprises alerting a user that the respective one of the current processes is an unused process based on the probability score being greater than the first threshold and less than a second threshold; and
the action comprises automatically terminating the respective one of the current processes based on the probability score being greater than the second threshold.

18. The system of claim 16, wherein the program instructions are executable to:
determining the respective one of the current processes is accessed by another one of the current processes; and
maintaining the respective one of the current processes in the computing system.

19. The system of claim 16, wherein the action comprises terminating the respective one of the current processes, and the program instructions are executable to:
determining the terminating the respective one of the current processes causes an unexpected error with another one of the current processes; and
adding the respective one of the current processes to a watchlist for further investigation.

20. The system of claim 16, wherein the action comprises terminating the respective one of the current processes, and the program instructions are executable to:
determining the terminating the respective one of the current processes causes an unexpected error with another one of the current processes;
updating training data to include the respective one of the current processes with a revised classification; and
retraining the process classification model using the updated training data.
